(19) United States
(12) Patent Application Publication
(10) Pub. No.: US 2004/0125439 A1
(43) Pub. Date: Jul. 1, 2004

(54) Inverted microscope having a binocular/photo tube

(75) Inventors: Peter Euteneuer, Lahnau (DE); Andreas Hund, Gleichen-Reinhausen (DE)

Correspondence Address: Robert P. Simpson, Esq., Simpson & Simpson, PLLC, 5555 Main Street, Williamsville, NY, 14221, US

(73) Assignee: Leica Microsystems Wetzlar GmbH, Wetzlar (DE)

(21) Appl. No.: 10/735,394

(22) Filed: Dec. 12, 2003

(30) Foreign Application Priority Data
Dec. 13, 2002 (DE) 202 19 371.3

(51) Int. Cl. G02B 21/36

(52) U.S. Cl. 359/368; 359/363

(57) ABSTRACT

An inverted microscope having a U-shaped microscope housing (1), on one limb (2) whereof is provided a horizontal changing surface (3) for optomechanical adaptation of a module, wherein the module (4) comprises a horizontally protruding base unit (5) having on the one hand a binocular tube (6) placed thereon, and on the other hand a photo tube (7), with photo device (8), placed thereon.

### CROSS REFERENCE TO RELATED APPLICATIONS

This application claims priority of the German utility model application 202 19 371.3, filed Dec. 13, 2002, which is incorporated by reference herein.

1. Field of the Invention

The application concerns an inverted microscope having a U-shaped microscope housing and a combined binocular/photo tube module adaptable on one limb of said housing. Said module comprises a tube changing surface located horizontally, and can in that manner be placed optically and mechanically on a housing limb.

2. Background of the Invention

U.S. Design Pat. No. 354,299 discloses an inverted microscope which comprises a binocular tube that is placed on one of the two U-limbs. This known device is designed in such a way that on the underside of the other U-limb, it has a flange-mounting capability for a camera. This means difficulty in handling for the microscope user, since there is not a clear view of all the operating functions of the adaptable add-on units.

Additionally known from U.S. Design Pat. No. 308,879 is an inverted microscope that comprises a V-shaped imaging beam path, the part of the observation beam path leading toward the user extending in an approximately 45-degree diagonal guide. Articulated onto this diagonal part of the instrument is a vertically downward-pointing photo tube onto which —after a double beam deflection—a camera can be attached. No further information about the internal equipment and the operation of the optical components is contained in this design document.

Also known from EP 479 005 B1 is a microscope having a diagonally extending observation beam path, in which there is provided in the diagonal observation beam path a likewise diagonally attachable housing from which on the one hand a portion of the beam can travel into a binocular eyepiece, and on the other hand a twice-deflected partial beam can travel into a photo device. A disadvantage of this design is the fact that the changing surface is not arranged horizontally, and that the vertical photo port prevents an unimpeded view of the specimen by the microscope user.

### SUMMARY OF THE INVENTION

It is therefore the object of the present invention to eliminate the disadvantages of the inverted microscope design known from the existing art, and to describe an ergonomic device which, with optimum usability, provides the operator with an unimpeded view of the specimen and of all other relevant operating “locations” of the microscope system.

This object is achieved by way of an inverted microscope according to the main claim. Further embodiments are evident from the dependent claims.

The advantages of the device according to the present invention are that the proposed combined binocular/photo tube module permits an unimpeded view of the specimen. The device as a whole moreover makes possible the use of a photo device of this kind even with a stand that is rotated 90° and a transmitted-light device that is rotated 180°. Lastly, there exists in particular the possibility of using eyepieces in the binocular viewing port having a correction different from that at the photo tube. For example, it is possible to use eyepieces with periplan correction in the binocular tube, while eyepieces or TV adapters with HC correction can be used in the photo beam.

### BRIEF DESCRIPTION OF THE DRAWINGS

The invention will be explained in more detail below with reference to the schematic drawings, in which:

FIG. 1 is a front view of the device according to the present invention; and

FIG. 2 is an overall view in which the transmitted-light device has been rotated 180° and the inverted microscope stand 90°.

### DETAILED DESCRIPTION OF THE INVENTION

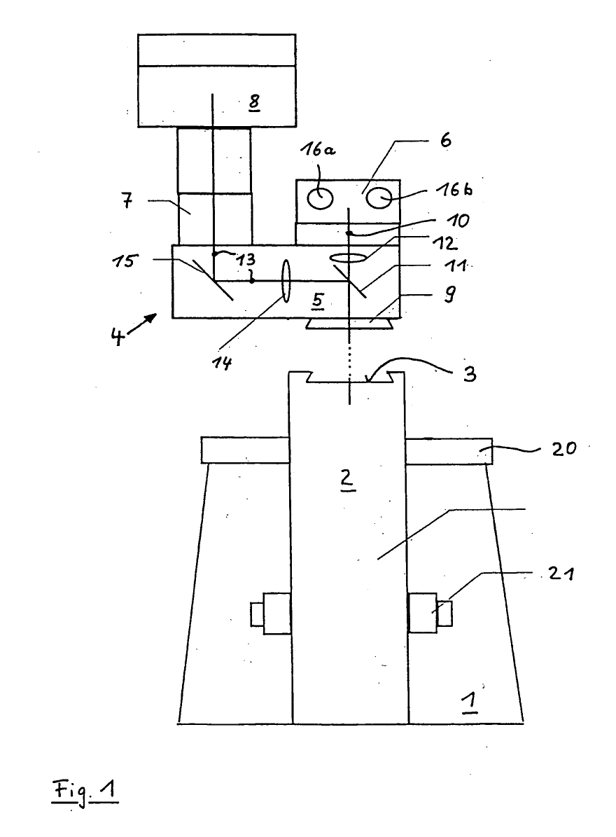

The number 1 designates a U-shaped microscope housing that, however, is visible in a front view in FIG. 1. One limb 2 of this microscope housing 1 is visible, a focusing drive 21 for Z displacement of microscope stage 20 being indicated in the lower region of 2. Located in the upper region of limb 2 is a horizontal changing surface 3 that matches the corresponding changing surface of module changing apparatus 9. The number 5 designates a horizontal base unit in which a first switchable element 11, for example a fully reflective mirror or a 50:50 beam splitter, is arranged. Following next along vertical optical axis 10 is a first tube lens 12. The imaging beam along optical axis 10 then encounters further deflection elements (not depicted) inside binocular tube 6. Proceeding from first optical element 11 is a horizontal partial beam—the so-called photo beam 13. It passes first through a second tube lens 14 and then encounters a second optical element 15, for example a deflection mirror. The vertical portion of photo beam 13 then passes through a photo tube 7 and from there into a photo device 8.

The entire combination arrangement is designed in modular fashion (cf. reference number 4). It must be emphasized here that this module can be in one piece, although it is also possible for it to be assembled exchangeably from several sub-modules. As already mentioned, first optical element 11 is movable out of the beam path. In that case the observation beam bundle travels unimpeded along optical axis 10 into binocular tube 6. If optical deflection element 11 is brought into the working position, and if it comprises a 50:50 beam splitter, then (as already described) one portion is deflected as photo beam 13 and another portion goes into binocular tube 6. A so-called “infinity” beam therefore exists in the region of the changing surface of module changing apparatus 9.

The device according to the invention is configured in such a way that while looking into the binocular tube, the operator can manipulate the specimen, the photo device, and also the focus drive in ergonomically favorable fashion.

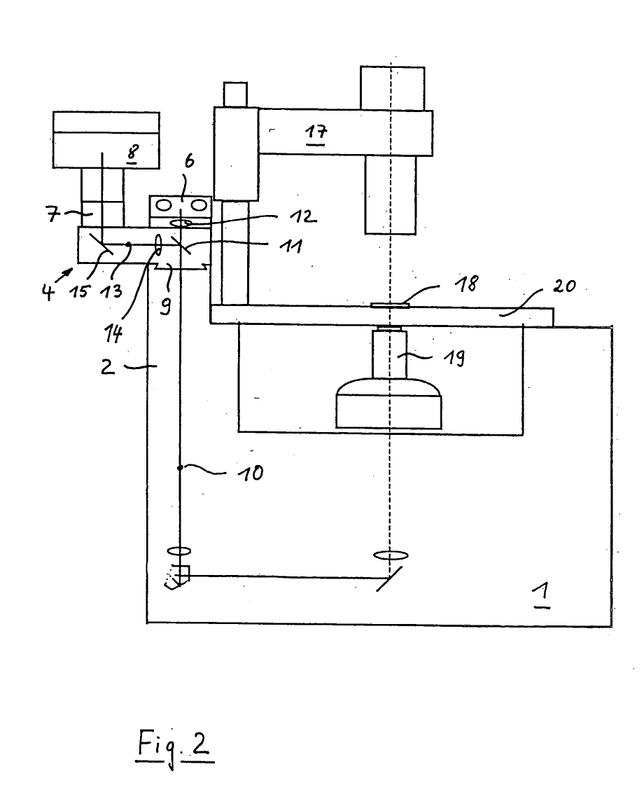

FIG. 2 shows the actual inventive apparatus, i.e. combination module 4, in a manner similar to FIG. 1. In addition, the inverted microscope stand with its U-shaped chassis part is depicted in the drawing as if it had been rotated 90° into the plane of the drawing. Also visible is transmitted-light device 17, which in turn has been shown rotated 180°. The number 18 designates the specimen resting on microscope stage 20. Objective 19 that is depicted can, of course, also be an objective turret system.

### Parts List

1 U-shaped microscope housing

2 One limb of (1)

3 Horizontal changing surface on (2)

4 Module

5 Horizontal base unit

6 Binocular tube

7 Photo tube

8 Photo device

9 Module changing device

10 Optical axis

11 First optical deflection element

12 First tube lens

13 Photo beam

14 Second tube lens

15 Second optical deflection element

16a, 16b Eyepiece(s) of (6)

17 Transmitted-light device

18 Specimen

19 Objective

20 Microscope stage

21 Focus drive

What is claimed is:

1. An inverted microscope having a U-shaped microscope housing (1), on one limb (2) whereof is provided a horizontal changing surface (3) for optomechanical adaptation of a module,
wherein said module (4) comprises a horizontally protruding base unit (5) having on the one hand a binocular tube (6) placed thereon, and on the other hand a photo tube (7), with photo device (8), placed thereon.

2. The inverted microscope as defined in claim 1, wherein the module (4) is embodied as a one-piece combination module (4; 5, 6, 7) and has on its underside a module changing apparatus (9) that corresponds to the horizontal changing apparatus (3).

3. The inverted microscope as defined in claim 1 or claim 2, wherein the vertical optical axis (10) of the observation beam bundle, extending in the one limb (2), penetrates through a first optical deflection element (11) after entering the base unit (5), and then passes through a first tube lens (12) arranged in the binocular tube (6), while the photo beam (13) deflected at the optical deflection element (11), after passage through a second tube lens (14) and after deflection at a second optical deflection element (15), enters the photo tube (7) with attached photo device (8).

4. The inverted microscope as defined in any of the foregoing claims, wherein the optical element (11) can be selectably brought into or out of the working position.

5. The inverted microscope as defined in any of the foregoing claims, wherein an infinity beam exists in the region of the changing surface of the module changing apparatus (9).

6. The inverted microscope as defined in any of the foregoing claims, wherein the eyepieces (16a, 16b) of the binocular tube (6) have a different degree of correction from those in the photo tube (7) or photo device (8).

7. The inverted microscope as defined in claim 6, wherein the eyepieces (16a, 16b) have a periplan correction, and the eyepieces or TV adapters in the photo tube (7) or photo device (8) have an HC correction.
